(19) United States
(12) Patent Application Publication
(10) Pub. No.: US 2016/0132839 A1
(43) Pub. Date: May 12, 2016

(54) SYSTEMS AND PROCESSES FOR FACILITIES MAINTENANCE SCHEDULING

(71) Applicant: Facilities Maintenance Planning, LLC, Carlsbad, CA (US)

(72) Inventor: David WS. Randolph, Sunnyvale, CA (US)

(21) Appl. No.: 14/936,597

(22) Filed: Nov. 9, 2015

Related U.S. Application Data
(60) Provisional application No. 62/077,214, filed on Nov. 8, 2014.

(51) Int. Cl. G06Q 10/00; G06F 17/30

(52) U.S. Cl. CPC G06Q 10/20; G06F 17/3087; G06F 17/30368; G06F 17/30377

(57) ABSTRACT

The process for facilities maintenance scheduling includes storing in a database at least one operational characteristic of at least one component requiring inspection over a service lifetime. The operational characteristic of the at least one component is monitored with a sensor and the status of the operational characteristic is communicated to the database over a communication network. The database updates the operational characteristic therein based on the status received from the sensor over the communication network, and adjusts an inspection schedule for the at least one component based on the status of the operational characteristic received by the database from the sensor over the communication network.

### BACKGROUND OF THE INVENTION

The present invention generally relates to systems and processes for facilities maintenance scheduling. More specifically, the present invention relates to systems and processes for monitoring, tracking, updating, and alerting maintenance personnel of the need to inspect and/or replace certain operational components that may be deployed in a facility or campus environment.

Facilities (e.g., buildings, equipment, machinery, and equivalent infrastructure) have various maintenance requirements, including schedules for inspections and replacement of major components, and costs for upkeep and replacement. Vast resources are spent to construct facilities and vast resources are needed to maintain those facilities. For example, according to the 2000 United States Census, 88% of schools in the United States are over 35 years old and 70% of schools are over 45 years old. This pattern holds for most of the facility infrastructure in the United States where 84% of all buildings are over 35 years old and 64% of all buildings are over 35 years old.

The desire and in most cases the legal requirement to maintain facilities in good repair places a premium on maintenance. Older buildings often present facility owner/operators with unexpected costs due to the inability to accurately predict when a facility component has reached the end of its useful life. New buildings that are constructed with increasingly sophisticated and complicated technology present facility owner/operators with additional maintenance challenges. Whether the challenges lie with maintaining aging infrastructure or preventing facility downtime from a smart facility system failure, owner/operators need a way to at least accurately evaluate the condition of their facility components at any point in time, predict the end of the useful life of various facility components, and plan for the replacement cost.

The prior art includes systems such as Computer Maintenance Management Systems (CMMS), Enterprise or Asset Management software, and Predictive Maintenance Software (sometimes referred to as PdM Software). CMMS systems are centered on Work Order systems. Work Order systems enable facility users to submit a Work Order online, which allows facility maintenance planners to prioritize corrective maintenance and to attend to requests in an equitable manner. Many CMMS systems add features that enable users to calendar the use of space, or track work orders for analysis of the systems that are causing the most repair requests. Additional features may include tracking repair costs, tracking vendors used for repairs, automatically generating work orders, and other features that build off of the accumulated work order data. Moreover, Enterprise or Asset Management software is a wide ranging suite of accounting software that focuses on the use and allocation of resources in areas such as production, procurement, and inventory control. Existing predictive maintenance software of the PdM class focuses on the statistical analysis of machinery and equipment. Various metrics (e.g., vibration and fluid monitoring) try to predict the useful life of equipment.

All the existing maintenance software systems described above fail to accurately predict the cost and timing to replace any combination of facility components, to maintain the components in good repair. For example, the prior art (1) fails to incorporate the effects of site specific environmental conditions and on-going maintenance, or the lack thereof, on the longevity of facility components; (2) fails to apply a component condition rating to each component to incorporate the effects of site specific environmental conditions and on-going maintenance, or the lack thereof, on the longevity of facility components; (3) fails to allow for updating the component condition rating and to automatically update the replacement and cost schedules based on the updated condition ratings to ensure that the replacement timing and cost schedules are accurate; (4) fails to provide an inspection schedule for updating the condition ratings; (5) fails to use software, hardware and wireless networks to automate the updating of condition ratings; (6) fails to integrate existing and future technology which may be capable of causing a variety of materials and equipment to self-report on the status of their condition and automatically update replacement timing and cost schedules; (7) fails to incorporate a cost escalator and term calculator to allow planners to consider various budgeting requirements by executing scenarios for various terms with various allowances for the cost of money over time; and (8) fails to incorporate a project budgeting mechanism that allows planners to add markups to the base component replacement costs to fully budget for secondary but necessary project costs.

There exists, therefore, a significant need for a facilities maintenance system and related process for providing predictive facilities maintenance that includes a database for storing information regarding the operational characteristics of one or more components that may need servicing during an operational lifetime, a communication network for the real-time exchange of information between the database and a sensor monitoring the operational characteristics of the one or more components, and a portable electronic device in communication with the network for receiving alerts from the database to conduct an inspection of components within a predetermined range of the portable electronic device, the process including creating and adjusting inspection and replacement schedules based on data received by the database from the sensor during the operational lifetime of the component. The present invention fulfills these needs and provides further related advantages.

### SUMMARY OF THE INVENTION

The process for facilities maintenance scheduling as disclosed herein includes steps for storing in a database at least one operational characteristic of at least one component requiring inspection over a service lifetime. The operational characteristic, e.g., may include one or more features of a component HVAC system (e.g., a compressor) or plumbing system (e.g., leaky toilet pipe) that may need periodic repair and/or replacement during an operational lifetime. The operational characteristic of the at least one component is monitored with a sensor. The status of that operational characteristic is then communicated to a database by the sensor over a communication network. The database then updates the operational characteristic for that component based on the status received from the sensor over the communication network and adjusts an inspection schedule accordingly. In one embodiment, the status sent by the sensor may include a condition rating for the at least one component that includes a “good” rating, a “fair” rating, a “poor” rating, or a “replace” rating. In the event the condition rating is the “poor” rating or the “replace” rating, the inspection schedule is accelerated to account for the deteriorating component. In this respect, the accelerated inspection may prompt earlier replacement to ensure the component (or assembly) remains in sufficient working condition and to avoid downtime. Alternatively, when the condition rating includes the “good” rating or the “fair” rating, the inspection schedule may be extended since the component may still be in good working condition and facility resources are more efficiently needed elsewhere.

The facilities maintenance scheduling process may further include the step of sending an alert to a portable electronic device carried by a technician that at least one component requires inspection or replacement. In this respect, the system may identify or track the location of the portable electronic device with a geo-locator and notify the technician of an inspection schedule specific to one or more operational characteristics of a plurality of components within a predetermined range of the location of the portable electronic device. As such, the technician may be able to quickly perform inspections when onsite, as opposed to losing precious time traveling from one part of a facility to another to conduct inspections. The technician may be able to use the portable electronic device to navigate through a series of menus to complete the inspection. When complete, the portable electronic device may deliver an inspection report to the database over the communication network, including the condition rating of the component and noting that the technician completed the inspection. Alternatively, if the technician does not have time to perform the inspection while onsite, the portable electronic device may deliver a report back to the database that the inspection was deferred until a later date. In the latter embodiment, the database may prompt the technician (the same or another) the next time a portable electronic device is within the predetermined range of the component that was deferred inspection.

The sensor may include an RFID reader, a portable electronic device, a gauge, or a nanotechnology sensor built into the at least one component. The RFID reader may engage in bilateral communication with a transmitter associated with the component to report conditional information. Alternatively, the portable electronic device may be used to manually inspect and update the operational characteristic of the component, as mentioned above. A nanotechnology sensor built into or otherwise associated with the component may provide real-time or periodic updates to the database, depending on the polling interval desired by the facility. In this respect, the sensor may monitor the operational characteristic at periodic intervals or otherwise perform inquiries of the operational characteristic of the component at periodic intervals.

The inspection schedule for at least one component may be based at least in part on a quantity of useful years, a component condition (mentioned above), and a date the at least one component was last inspected. Components may be tagged as a critical component to accelerate or prioritize inspections, or the inspection schedule can be modified at least in part on environmental wear conditions unique to the area where the component has been deployed (e.g., components in harsher environments may be inspected more often). Especially when the at least one component includes multiple components having multiple operational characteristics, the database may create an inspection schedule, a replacement schedule, and a cost schedule based on the status of the multiple operational characteristics of the multiple components in the database so the facility can better plan for future inspections and budget for repair costs. In one embodiment, the cost schedule may be based on a user defined duration (e.g., set by specific starting and ending dates) and may permit the extrapolation of expenses (including interest rates) over the user defined term.

In another embodiment as disclosed herein, a process for facilities maintenance scheduling includes storing at least one operational characteristic of a plurality of components in a database, monitoring the at least one operational characteristic for each of the plurality of components with one or more sensors, and communicating a status of each of the at least one operational characteristics of the plurality of components monitored by the one or more sensors to the database over a communication network. In one embodiment, the status may include a condition rating such as a “good” rating, a “fair” rating, a “poor” rating, or a “replace” rating. The at least one operational characteristic for each of the plurality of components in the database may be updated based on the status (e.g., the condition rating) received from the one or more sensors over the communication network. Accordingly, the database may adjust an inspection schedule for the plurality of components based on the status of the respective operational characteristic received by the database from the one or more sensors over the communication network. In one embodiment, the inspection schedule may be accelerated when the condition rating includes the “poor” rating or the “replace” rating. In another embodiment, the inspection schedule may be extended when the condition rating includes the “good” rating or the “fair” rating. The database may then send an alert to a portable electronic device with the inspection schedule for at least a portion of the plurality of components within a predetermined range of the portable electronic device when at least one component requires inspection.

In one aspect of this embodiment, the database may identify a location of the portable electronic device with a geo-locator, and identify certain components within the predefined range of the portable electronic device. Of course, the portable electronic device may engage in bilateral communication with the database, including sending an inspection update to the database in response to the alert. In one embodiment, the inspection update may include a completed inspection report when the technician inspects the component. Alternatively, the inspection update may be a deferred inspection report, when the technician does not inspect the component. In another aspect of this embodiment, the one or more sensors may query the operational characteristics of the components at periodic intervals to ensure the system remains updated. In this respect, the system may create an inspection schedule, a replacement schedule, and a cost schedule based on the status of the plurality of components in the database, wherein the inspection schedule is based at least in part on a quantity of useful years, a component condition, and a date that each of the at least one operational characteristics were last inspected.

In another aspect of the embodiments disclosed herein, a facilities maintenance system may include a database storing at least one operational characteristic of a component requiring maintenance over a service lifetime. At lease one sensor deployed relative to the component may monitor the at least one operational characteristic of the component during the service lifetime. The sensor may include, e.g., a moisture sensor, a fabric sensor, a nanotechnology sensor built into the at least one component, a pressure sensor, etc. A communication network coupled with the database and the sensor permits the exchange of information therebetween, including a status of the operational characteristic monitored by the sensor. The communication network may include a wireless communication network (e.g., Wi-Fi) or a wired communication network (e.g., Ethernet). Additionally, at least one portable electronic device may be in communication with the database over the communication network. In one embodiment, the portable electronic device may include a smartphone, tablet or laptop computer. The at least one portable electronic device may receive an inspection schedule from the database over the communication network based at least in part on the status of the operational characteristic monitored by the sensor.

Other features and advantages of the present invention may become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic environmental view of one embodiment of a facilities maintenance system as disclosed herein;

FIG. 2 is a block diagram illustrating determining the cost to replace a component;

FIG. 3 is a block diagram illustrating determining the Useful Years, Replacement Date, and Inspection Date for a component;

FIG. 4 is a block diagram illustrating determining the Useful Years, Replacement Date, and Inspection Date conditioned by the component Condition Rating and Date of the Last Inspection;

FIG. 5 is a block diagram illustrating determining the Useful Years, Replacement Date, and Inspection Date conditioned by the component Condition Rating and Date of the Last Inspection;

FIG. 6 is a block diagram illustrating determining the Useful Years, Replacement Date, and Inspection Date conditioned by the component Condition Rating and Date of the Last Inspection;

FIG. 7 is a block diagram illustrating determining the Useful Years, Replacement Date, and Inspection Date conditioned by the component Condition Rating;

FIG. 8 is a block diagram illustrating determining the Useful Years, Replacement Date, and Inspection Date conditioned by the component Condition Rating and Date of the Last Inspection;

FIG. 9 is a block diagram illustrating determining the Useful Years, Replacement Date, and Inspection Date conditioned by the component Condition Rating and Date of the Last Inspection;

FIG. 10 is a block diagram illustrating determining the Useful Years, Replacement Date, and Inspection Date conditioned by the component Condition Rating and Date of the Last Inspection;

FIG. 11 is a block diagram illustrating determining the Useful Years, Replacement Date, and Inspection Date conditioned by the component Condition Rating;

FIG. 12 is a block diagram illustrating determining a Conditioned Replacement Date and Various Cost by Date Summaries for Various Tracked Components Located in Various Spaces;

FIG. 13 is a block diagram illustrating determining a Conditioned Replacement Date and Various Cost by Date Summaries for Various Tracked Components Located in Various Spaces;

FIG. 14 is a block diagram illustrating determining Various Cost by Date, Term & Cost of Money Summaries for Various Tracked Components Located in Various Spaces;

FIG. 15 is a block diagram illustrating determining Various Cost by Date, Term & Cost of Money Summaries for Various Tracked Components Located in Various Spaces;

FIG. 16 is a block diagram illustrating updating the condition ratings through inspections by incorporating inspection alerts and inspection updates into the course of daily maintenance operations;

FIG. 17 is a block diagram illustrating automation of condition ratings;

FIG. 18 is a block diagram illustrating a typical facility and the typical tracked components, in accordance with one embodiment disclosed herein; and

FIG. 19 illustrates a process for facilitating predictive facilities maintenance.

### DETAILED DESCRIPTION OF THE PREFERRED EMBODIMENTS

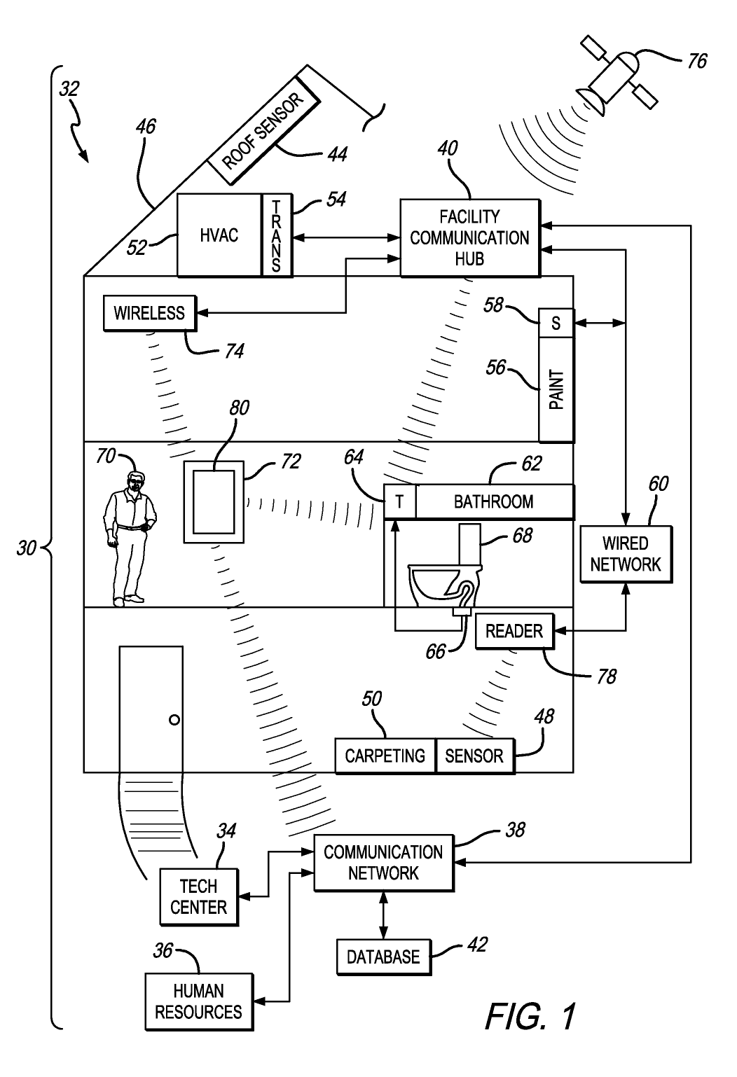

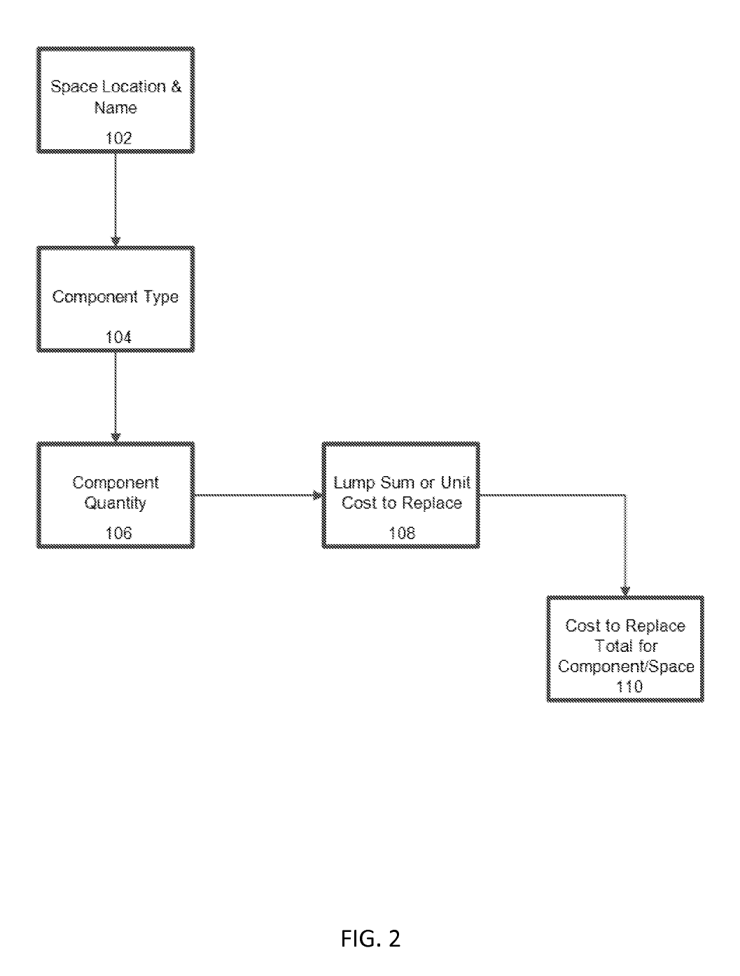

As shown and described in the exemplary drawings for purposes of illustration, a facilities maintenance system is referred to generally in FIG. 1 by the reference numeral 30 and the related process for providing predictive facilities maintenance is referred to generally in FIGS. 2-19. For example, as shown in shown in FIG. 1, the facilities maintenance system 30 may be deployed for use in a building 32 or as part of a campus that may include multiple buildings, such as a tech center 34 and a human resources building 36, or other indoor and/or outdoor facilities. One or more of the building 32, the tech center 34 and/or the human resources building 36 are preferably in communication with a communication network 38 that may be central to each of the buildings and other facilities on campus. The same may be true in the context of the building 32, namely the communication network 38 may be the central communication device (e.g., a router or communications hub) to all the devices deployed therein. The communication network 38 is shown in FIG. 1 generally providing bilateral communication with each of the tech center 34 and/or the human resources building 36. FIG. 1 more specifically illustrates the communication network 38 in bilateral communication with a facility communication hub 40, which may provide wired or wireless communication to a variety of devices within the building 32, as described in more detail below. The communication network 38 is also coupled with a database 42 for bilateral communication therewith in accordance with the embodiments disclosed herein.

The facilities maintenance system 30 may use nanotechnology embedded in materials to enable the material components to report status and/or condition information, especially status reports that may not be visible to the naked eye. In this respect, the building 32 may include various sensors and devices for communicating reports to the database 42 by way of the communication network 38, such as by way of the facility communication hub 40. More specifically, the building 32 of the facilities maintenance system 30 may include a moisture sensor 44 that can report and pinpoint leaks in a roof 46. A fabric sensor 48 may be embedded or otherwise associated with fabric (e.g., fabrics used on floors (i.e., a carpet 50) and/or walls (e.g., tack boards)) that can report on fiber length or excessive particle accumulation. Additionally, equipment such as an HVAC system 52 may include a transmitter 54 for reporting specific operating conditions, such as operating efficiency, age, hours of operation, date of last service, component functionality, etc. In another aspect of FIG. 1, chemical changes to a wall of paint 56 may indicate a need to repaint. For example, a sensor 58 may be able to determine if the wall of paint 56 is subject to “chalking”, the formation of fine powder on the surface of paint film due to weathering. A paint coating losing the ability to chalk could be detected chemically by the sensor 58 and communicated to the database 42 by way of a wired network 60 in communication with the facility communication hub 40 and the communication network 38. In another aspect of FIG. 1, the building 32 may include a bathroom 62 that includes a wireless transmitter 64 in bilateral communication with a flow switch 66 (to indicate leaks) embedded in a plumbing fixture 68. Other examples might include sensors or reporting devices designed to indicate and report overheating motors, pressure loss, excessive rotation pressure (e.g., bearings wearing out), excessive accumulation of materials on filters (e.g., indicating the need to change or clean a filter), light sensors in particle board could report delamination of Formica or other veneers on cabinets etc. Of course, a person of ordinary skill in the art will readily recognize that the facilities maintenance system 30 may include one or more sensors or reporting devices designed to track and report the condition of one or more items that may need to be maintained in a building (such as the building 32) or throughout a campus (e.g., the building 32, the tech center 34, the human resources building 36) or with respect to other indoor and/or outdoor facilities as the case may warrant.

Strategically placed wireless communication devices and/or sensors may further detect the presence of a technician in a room and/or building and may serve as an intermediate relay. For example, as shown in FIG. 1, a technician 70 is holding a portable electronic device 72 (e.g., a smartphone, laptop, tablet, etc.) in wireless communication with a wireless router 74, the wireless transmitter 64 in the bathroom 62, or even directly with the communication network 38 (e.g., by way of cellular data). One or more of the above-mentioned sensors or data communication devices could relay condition information from embedded nanotechnology by way of wired and/or wireless networks to the main server or the database 42 by way of the communication network 38. In this respect, the technician 70 may receive real-time data updates regarding certain maintenance schedules and conditional information of devices within the building 32, or within a specific room, such as the bathroom 62. For example, the technician 70 may receive inspection information or an alert that an inspection is needed and the technician 70 may be guided through the appropriate steps for completing an inspection. Thereafter, the system database 42 is updated by way of the communication network 38 for future re-inspection and replacement conditions. General factors that affect the re-inspection and replacement schedule may include expected life of the device or product, year installed compared to the current year, last condition rating, unit cost, quantity available, etc.

The database 42 preferably includes information regarding facilities equipment, fixtures, finishes with component types, location, quantities, etc. This is just a short list of examples. Persons of ordinary skill in the art will readily recognize that the database 42 could include other maintenance information as needed or desired. In this respect, the database 42 can be customized and can be configured to track any number of components and/or subcomponents, including replacement cost, expected lifespan, component condition evaluation, rating, etc. The database 42 may also include information regarding component wear factors and priority component tagging, allowing adjustments to the expected lifespan of a component based on usage (e.g., carpet in an entry area may be assigned a higher wear factor than carpet in a book storage room) and importance (e.g., an air pressure control machine that is critical can be prioritized for replacement tracking over a standard room air handling unit).

The database 42 may generate schedules that identify the timing, location, and cost to replace all tracked components. Replacement and cost schedules can be determined by space, building (or a combination of buildings), year (or combination of years), component type (combination of component types), etc. The database 42 may generate an inspection schedule and may notify maintenance technicians to periodically update the condition of the tracked components, such as by way of sending a real-time communication alert to the portable electronic device 72 over the communication network 38. Critical components can also be flagged to ensure that the timing for the replacement of these components may be prioritized if the condition falls below a benchmark or threshold value.

The database 42 may automatically maintain, accelerate, or decelerate the inspection, replacement and cost schedules based on the updated condition ratings. This central feature ensures that, over time, the predicted replacement schedules accurately reflect actual maintenance and environmental factors affecting the longevity of the components. In this respect, the database 42 may update component condition ratings. Maintenance technicians equipped with the portable electronic device 72 may communicate directly with the database 42 to obtain pertinent component condition information. The position of the portable electronic device 72 may be determined by one of a number of different sensors, such as a general geo-positioning device (e.g., a GPS satellite 76 or the like), or a more specific location sensor (e.g., an RFID reader 78, the wireless router 74, the wireless transmitter 64, or some other sensor/transmitter known in the art for determining location). In one embodiment, the GPS satellite 76 may be able to determine the position of the portable electronic device 72 in the building 32, while a more specific sensor, such as the wireless transmitter 64 in the bathroom 62, may be able to more specifically locate the portable electronic device 72 in a particular room or floor (e.g., the second floor as shown in FIG. 1). In one embodiment, the facilities maintenance system 30 may make use of the communication network 38, the facility communication hub 40, the moisture sensor 44, the fabric sensor 48, the transmitter 54, the sensor 58, the wired network 60, the wireless transmitter 64, the wireless router 74, the GPS satellite 76, and/or the RFID reader 78, or other such Wide Area Networks (WAN), Local Area Networks (LAN), Wireless Local Area Networks (Wi-Fi), or the like, as may be needed or desired, to communicate data throughout the system 30, and specifically between the database 42 and/or the portable electronic device 72 carried by the technician 70.

In one embodiment, the facilities maintenance system 30 may relay a communication signal over the communication network 38 to cause a screen 80 on the portable electronic device 72 to alert the technician 70 of the need for a scheduled inspection for the particular space where the technician 70 is located. In the embodiment shown in FIG. 1, upon entry of the second floor of the building 32, automatic wireless communication of the portable electronic device 72 with the transmitter 64 may send a message back to the database 42 indicating that the technician 70 is on the second floor of the building 32 and near the bathroom 62. In this respect, if the database 42 determines that an inspection of the plumbing fixture 68 is needed, the database 42 may automatically relay an alert to the screen 80 of the portable electronic device 72, indicating the need to re-inspect the plumbing fixture 68. This enables the technician 70 to inspect the flow switch 66 while on-site. The technician 70 may then update the database 42 with information regarding the condition of the inspected component (i.e., the plumbing fixture 68 in the FIG. 1 example). The technician 70 could open an application on the screen 80 of the portable electronic device 72 and navigate through a series of options to enter and record that the plumbing fixture 68 has, e.g., deteriorated. This information is then communicated back to the database 42 over the communication network 38. The database 42 may then schedule and provide equipment and materials status reporting and other updates in real-time, to the appropriate personnel, to ensure that the plumbing fixture 68 is timely repaired. Alternatively, the technician may decline to conduct the inspection, at which point the database 42 may also be updated accordingly.

In another aspect of the facilities maintenance system 30 disclosed herein, the database 42 may summarize the cost and replacement timing of facility components with varying levels of complexity. Thus, the cost and timing for the replacement of a single component type in one space or multiple components across an entire campus, district, or complex can be considered in real-time. To facilitate fiscal planning, the database 42 may include a user determined cost escalator term calculator, and budget markup mechanism providing the ability to consider various budgeting requirements by executing scenarios for various terms with various allowances for project costs and the cost of money over time. The may be used for one or more components within the scope of the facilities maintenance system 30.

Of course, as used herein, the word component has broad application across virtually any part, subpart, assembly, subassembly, etc. that may be within the purview of the facilities maintenance system 30. Accordingly, the database 42 may be required to track and store a large variety of items over time. For example, in the example shown in FIG. 1, such a component may include the carpet 50, the HVAC system 52, its various components and/or subcomponents, the wall of paint 56, or the flow switch 66. Of course, the component or components could include virtually any other device, assembly, subassembly, part, etc. that may need servicing or replacement during its operational lifetime. As briefly mentioned above, such a component could be deployed in a variety of environments, including indoor or outdoor facilities, including those associated with a building, campus, etc. Accordingly, such devices are more generally grouped together and referenced herein as a component or components.

Moreover, the phrase Condition Rating references an evaluation of the current condition of a particular component or of the need to replace the component (e.g., the Conditional Rating may include “Good”, “Fair”, “Poor”, “Replace” ratings); the phrase Critical Component references an importance tag assigned to a selected component and may be used to accelerate the Inspection Schedule and/or the Replacement Timing Schedule (e.g., by an amount that is in addition to the conditions described herein that routinely accelerate the Inspection Schedule and/or the Replacement Timing Schedule) if the component receives a Condition Rating below a certain bench mark (e.g., below “Good”, or “Fair”); the phrase Current Year references the current calendar year; the phrase End Year references a user determined variable defining the end of a term (e.g., the end of a fiscal year that may be used for analysis and/or planning purposes); the phrase Estimated Cost to Replace references the estimated cost to replace a component expressed as a lump sum or a unit cost; the phrase Expected Lifespan references the expected useful life of a particular component when new; the phrase Inspection Date references the date for inspecting a component and updating the Condition Rating of the component; the phrase Inspection Schedule references a chart or schedule of dates for inspecting and updating the Condition Rating of at least one component; the phrase Last Inspection Date references the date when the component was last inspected; the phrase Replacement Cost Schedule references a chart or schedule of the Estimated Cost to Replace at least one component (or multiple components) expressed in relation to a date or period of time; the phrase Replacement Cost references the Estimated Cost to Replace multiplied by a count or quantity of components and expressed as a lump sum; the phrase Replacement Date references a date for replacing a component; the phrase Replacement Timing Schedule references a chart and/or a schedule of dates for replacing at least one component; the phrase Start Year references a user determined variable defining the start of a term (e.g., the start of a fiscal year that may be used for analysis and/or planning purposes); the phrase Useful Years references the remaining useful life a component; the phrase Calculated Useful Years references the remaining useful life of a component based on one of the following: Calculated Useful Years=Expected Lifespan−(Current Year−Year Installed) or Calculated Useful Years=Expected Lifespan−(Current Year−Year Modernized); the phrase Reported Useful Years references the remaining useful life of a component after the Calculated Useful Years has been modified based on the Condition Rating of the component; the phrase Year Installed references the year that a facility was constructed and a component was placed into service; and the phrase Year Modernized references the year some portion of a facility was modernized and a component was placed into service.

One aspect of the database 42 providing automatic alerts to the technician 70 is that the database 42 may determine desired inspection dates and/or replacement dates of a component based on several factors. For example, when the Expected Lifespan of a Component is sufficiently long, and the Component rating is “Good” or “Fair”, and the Last Inspection Date is within an acceptable period of time and the Calculated Useful Years and the Reported Useful Years may be the same—the Calculated Useful Years and the Reported Useful Years will decrease in a 1:1 ratio with the passing of time. In this example, the next Inspection Date may be determined by: Inspection Date=Year Installed (or Year Modernized)+Expected Lifespan−passing period of time (e.g., “2” or “3” years). The corresponding Replacement Date may then be determined by: Replacement Date=Year Installed (or Year Modernized)+Expected Lifespan.

When the Expected Lifespan of the component is still significantly long, but the Condition Rating is “Poor”, the Reported Useful Years may be less than the Useful Years. In this condition, the Inspection Date and the projected Replacement Date may be accelerated.

When the component Expected Lifespan is still significantly long, but the Condition Rating of the Component is “Replace”, the Reported Useful Years may be set to “0” or “1” or otherwise set to indicate that the Useful Years are exhausted. The Inspection Date may be changed to indicate that replacement is immediately needed. Thus, the projected Replacement Date may be changed to the Current Year or the Current Year plus some value (e.g., “1”) to indicate that immediate replacement is needed.

When the Expected Lifespan of the component approaches the end of the span, and the Condition Rating is “Good” or “Fair”, and the Last Inspection Date is within an acceptable period of time, the Reported Useful Years may be greater than the Calculated Useful Years. The Inspection Date may thus be based on: Inspection Date=Year Installed (or Year Modernized)+Expected Lifespan+some period of time (e.g., “2” or “3” years). Accordingly, the Replacement Date may be based on: Replacement Date=Year Installed (or Year Modernized)+Expected Lifespan+some period of time (e.g., “4” or “5” years).

When the Expected Lifespan of the component approaches the end of the span, and the Condition Rating of the Component is “Good” or “Fair”, but the Last Inspection Date is not within an acceptable period of time, the Reported Useful Years may be greater than the Calculated Useful Years. Here, the Inspection Date may be accelerated (if the component has not been tagged as a Critical Component) or the Inspection Date may be the Current Year (if the component has been tagged as a Critical Component). The Replacement Date may then be based on: Replacement Date=Year Installed (or Year Modernized)+Expected Lifespan.

When the Condition Rating of the component is “Poor”, the Reported Useful Years may be less than the Calculated Useful Years. Here, the Inspection Date and the projected Replacement Date may be accelerated. When the Condition Rating of the component is “Replace,” the Reported Useful Years may be set to “0” or “1” or otherwise set to indicate that useful years are exhausted. The Inspection Date may be changed to indicate that replacement is needed immediately. Accordingly, the Replacement Date may be changed to the Current Year or the Current Year plus some value (e.g., “Current Year plus 1”) if immediate replacement is indicated but the component is not tagged as a Critical Component).

When the Expected Lifespan of the component has reached or exceeds the end of the Expected Lifespan, and the Condition Rating of the component is “Good” or “Fair,” but the Last Inspection Date is not within an acceptable period of time, the Reported Useful Years may be greater than the Calculated Useful Years. As such, the Inspection Date may be the Current Year and the Replacement Date may be based on: Replacement Date=Year Installed (or Year Modernized)+Expected Lifespan+a period of time.

When the Expected Lifespan of the component has reached or exceeds the end of the Expected Lifespan, and the Condition Rating of the Component is “Poor,” and the component has not been tagged as a Critical Component, the Reported Useful Years may be greater than the Calculated Useful Years. The Inspection Date may be the Current Year plus some period of time (e.g., “Current Year Plus 2”). The projected Replacement Date may be the Current Year plus some period of time (e.g., “Current Year Plus 3”).

When the Expected Lifespan of the component has reached or exceeds the end of the Expected Lifespan, and the Condition Rating of the component is “Replace,” the Reported Useful Years may be set to “0” or “1” or otherwise indicate that useful years are exhausted. The Inspection Date may be changed to indicate that replacement is needed immediately. The projected Replacement Date may be changed to the Current Year or the Current Year plus some value (e.g. “1” if immediate replacement is indicated but the component is not tagged as a Critical Component).

For all the conditions above, the Replacement Cost Schedules may be maintained, decelerated, or accelerated based on changes to component Replacement Dates and Critical Component tagging.

FIG. 2 is a block diagram generally illustrating the steps for determining the cost to replace a component within the facilities maintenance system 30. The database 42 may include a database entry identifying a space location and name 102 of each component. This information may be stored for each component type 104. A component quantity 106 provides information regarding the amount of the component type 104 in any particular space location 102. For example, the component quantity 106 may include a number of the component type 104 (e.g., five of the HVAC systems 52 in the building 32) or a unit quantity (e.g., measurable in some quantity such as square feet, square meters, etc. of the carpet 50). A lump sum or unit cost to replace 108 provides the actual cost information to replace each of the component type 104 (e.g., the cost to replace one of the HVAC systems 52 or the cost/square foot to replace the carpet 50). The result of multiplying the component quantity 106 by the cost to replace 108 provides the resulting value in a cost to replace total 110 for the component type 104 in a space location 102.

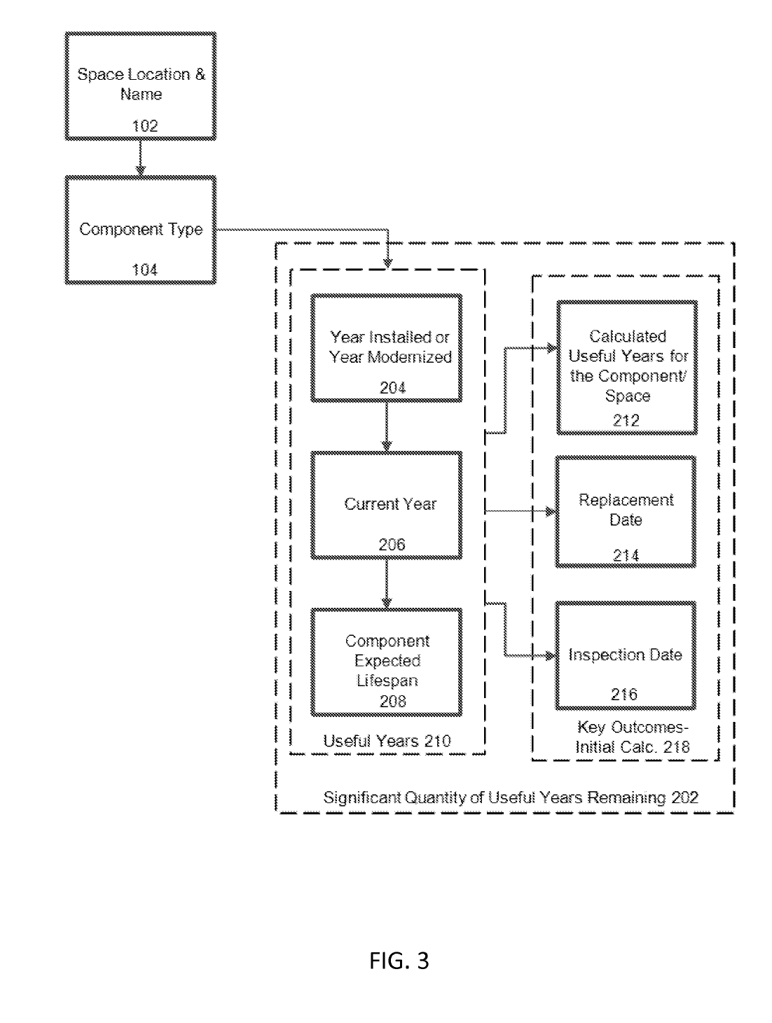

FIG. 3 is a block diagram more specifically illustrating determining the useful years, replacement date, and inspection date for the component type 104, discussed above with respect to FIG. 2. First, the space location and name 102 is identified for a specific component type 104. A year installed or year modernized 204 is subtracted from the current year 206 and the result is subtracted from a Component Expected Lifespan 208. A dashed block 210 connecting the blocks 204, 206 & 208 indicates that this provides a central calculation, i.e., Useful Years 210. The result of this calculation is shown again in a Calculated Useful Years for the Component/Space 212. A predicted Replacement Date 214 is obtained by adding the Year Installed or Year Modernized 204 with the Component Expected Lifespan 208. An Inspection Date 216 is determined by taking a Replacement Date 214 and subtracting an appropriate amount of time to place the inspection date ahead of the replacement date. The dashed block around blocks 212, 214, and 216 indicate key outcomes, e.g., Key Outcomes-Initial Calc. 218 is unmodified or “unconditioned” by user evaluations of the component present wear condition. One key “conditioning” variable used to calibrate the Key Outcomes-Initial Calc. 218 to a range of time in the component Expected Lifespan 208 is shown, Significant Quantity of Useful Years Remaining 202.

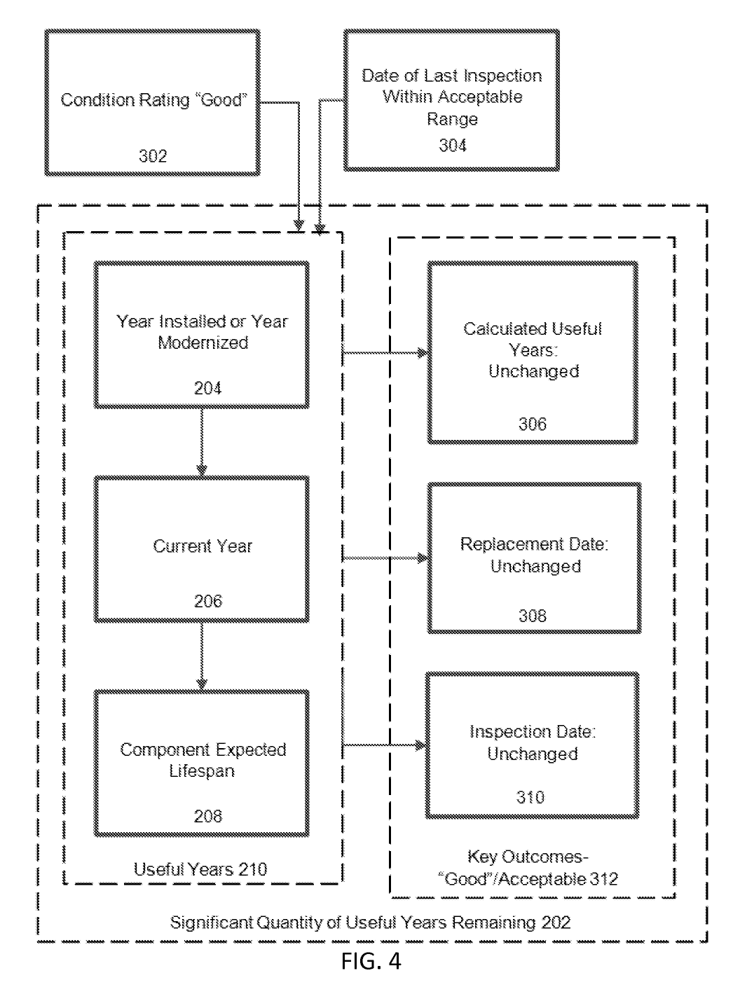

FIG. 4 illustrates a block diagram of how the Useful Years, Replacement Date, and Inspection Date are determined and conditioned by the component Condition Rating 302 and Date of the Last Inspection 304, in accordance with one embodiment disclosed herein. Here the component Condition Rating is good as indicated by Condition Rating “Good” 302, and the date of the last inspection is within an acceptable range as indicated by Last Inspection Date Within Acceptable Range 304. Consequently the calculations used to determine the dashed block Useful Years 210 result in the same values for the remaining Useful Years 306, the Replacement Date 308, and the Inspection Date 310 that would have resulted without conditioning for wear (“Good”, “Fair”, “Poor”, “Replace”) and the Last Inspection Date. This is indicated by Calculated Useful Years: Unchanged 306, Replacement Date: Unchanged 308, and Inspection Date: Unchanged 310. This combination of Key Outcomes is grouped for these conditions as indicated by the dashed block Key Outcomes-“Good”/Acceptable 312. This holds so long as the main calibration variable Significant Quantity of Useful Years Remaining 202 is true.

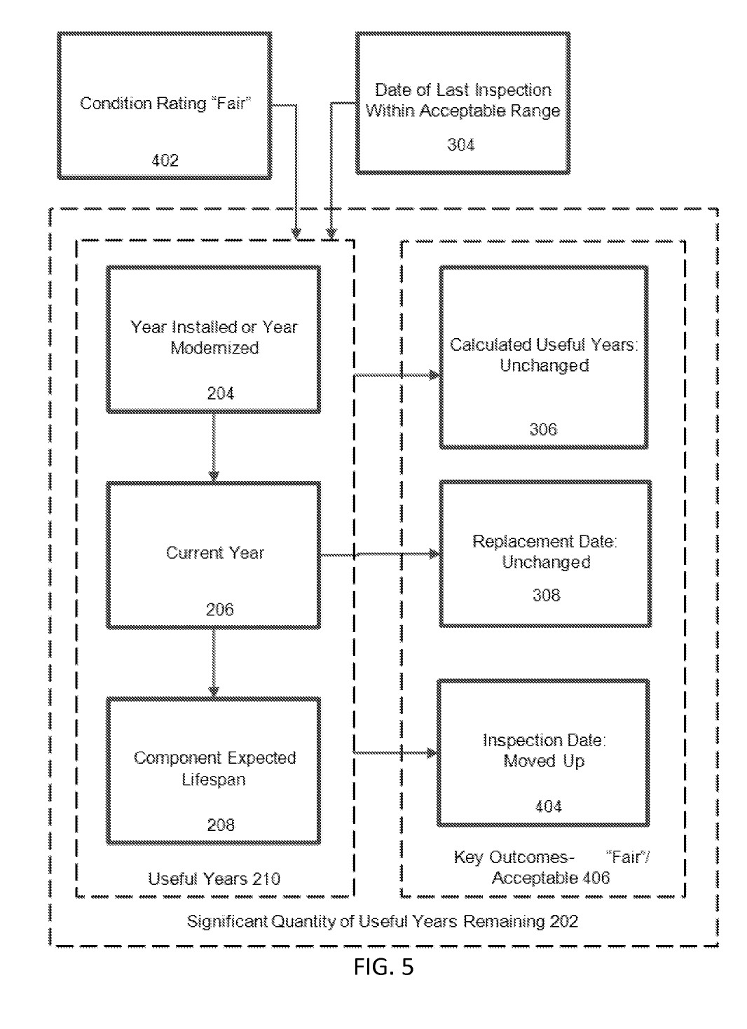

FIG. 5 illustrates a block diagram of how the Useful Years, the Replacement Date, and the Inspection Date are determined and conditioned by the component Condition Rating 402 and Date of the Last Inspection 304, in accordance with one embodiment disclosed herein. Here, the component Condition Rating is fair as indicated by Condition Rating “Fair” 402, and the date of the last inspection is still within an acceptable range has indicated by Last Inspection Date Within Acceptable Range 304. Since the condition of the component has deteriorated from good to fair, but the component may still have an Expected Lifespan 208 that is typical, the Calculated Useful Years 210 and predicted Replacement Date 308 are unchanged, but the database 42 may accelerate or “move up” the inspection schedule Inspection Date 404 to an earlier date. This is indicated by Calculated Useful Years: Unchanged 306, Replacement Date: Unchanged 308, and Inspection Date: Moved Up 404. This combination of Key Outcomes is grouped for these conditions as indicated by the dashed block Key Outcomes-“Fair”/Acceptable 406. This again holds true so long as the main calibration variable Significant Quantity of Useful Years Remaining 202 is true.

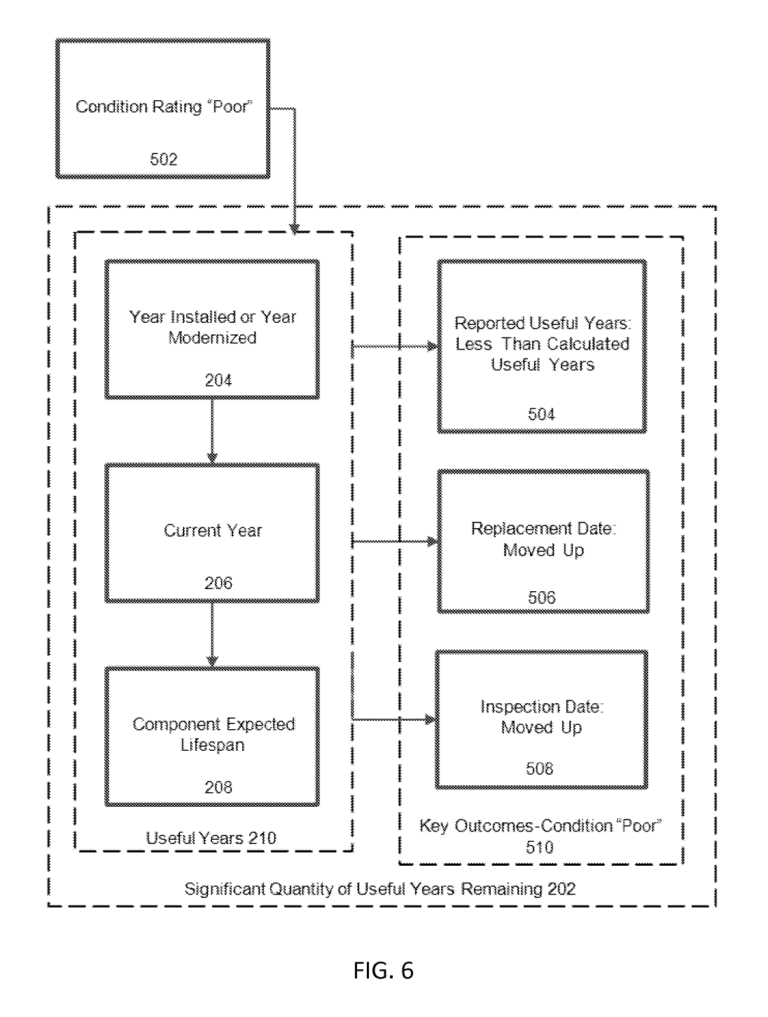

FIG. 6 illustrates a block diagram of how the Useful Years, the Replacement Date, and the Inspection Date are determined and conditioned by the component Condition Rating alone, in accordance with one embodiment disclosed herein. The Useful Years 210, Replacement Date, and Inspection Date first shown in FIG. 3 is conditioned according to the component Condition Rating and the Date of the Last Inspection. When the Condition Rating 502 is “Poor,” the Date of the Last Inspection (shown in FIG. 4) is ignored. Consequently adjustments are made to the calculations arising from Useful Years 210. It should be noted here that the Calculated Useful Years may be based on: Calculated Useful Years=Expected Lifespan−(Current Year−Year Installed/Modernized).

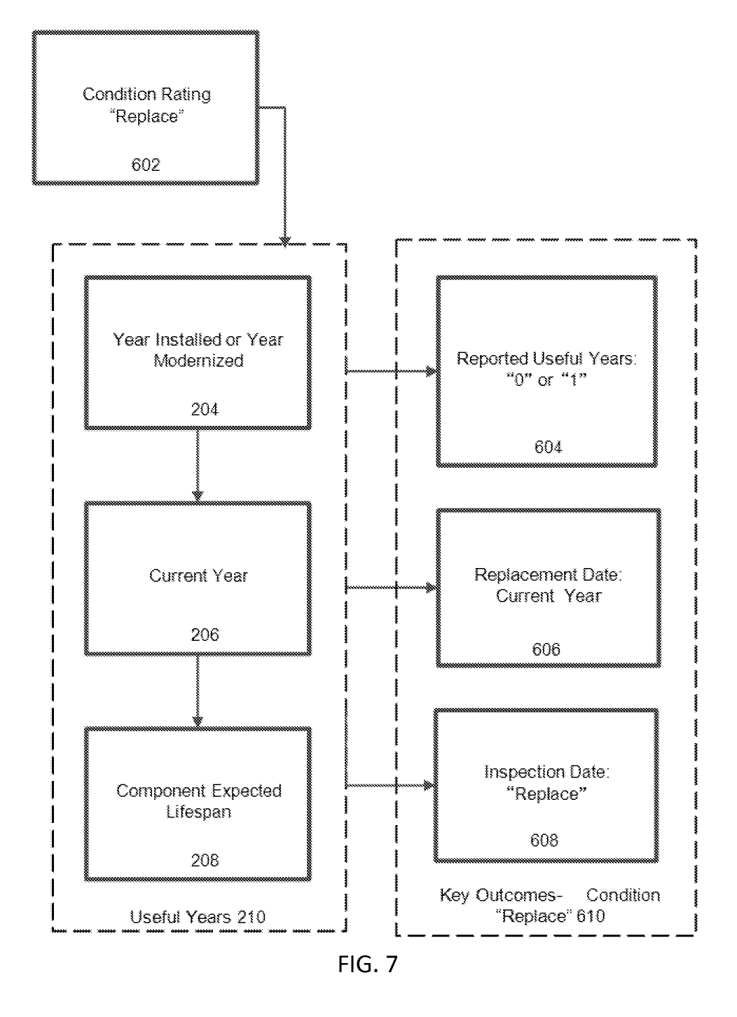

When the Condition Rating 502 is “Poor” or “Replace” (see block 602 in FIG. 7) the Reported Useful Years 504 is less than the Calculated Useful Years 210 as shown by Reported Useful Years 504: Less Than Calculated Useful Years. The poor rating indicates that the component is not expected to remain in serviceable condition for its typical Expected Lifespan 208 especially if the goal is to meet the legal standard of maintaining facilities in “Good Repair.” Consequently, both the Inspection Date 508 and the predicted Replacement Date 506 are advanced in time as indicated by Replacement Date: Moved Up 506 and Inspection Date: Moved Up 508. This combination of Key Outcomes is grouped for these conditions as indicated by the dashed block Key Outcomes—Condition “Poor” 510. This again remains the case so long as the main calibration variable Significant Quantity of Useful Years Remaining 202 is true.

FIG. 7 illustrates a block diagram of how the Useful Years, the Replacement Date, and the Inspection Date are determined and conditioned by the component Condition Rating 602, in accordance with another embodiment disclosed herein. Here, the Component Condition has been evaluated to be “Unacceptable” and in need of replacement as indicated in Condition Rating 602 “Replace.” Year Installed or Year Modernized 204, Current Year 206, Component Expected Lifespan 208, and Useful Years 210 are ignored. All the values represented in the Key Outcomes block 610 are adjusted to reflect the need for replacement. Depending on the criticality of the component, it may be appropriate to indicate immediate replacement is needed or it may be appropriate to replace the component in the near future. This is indicated by Reported Useful Years: “0” or “1” 604, and Replacement Date: Current Year 606. There is no need for further inspections so the inspection date, a numerical value, is eliminated and replaced with an alert as shown in Inspection Date: “Replace” 608. This combination of Key Outcomes, grouped for these conditions is indicated by the dashed block Key Outcomes-Condition “Replace” 610. It does not matter when in the Expected Lifespan 208 this evaluation is made, hence the main calibration variable Significant Quantity of Useful Years Remaining is not a factor and is not shown.

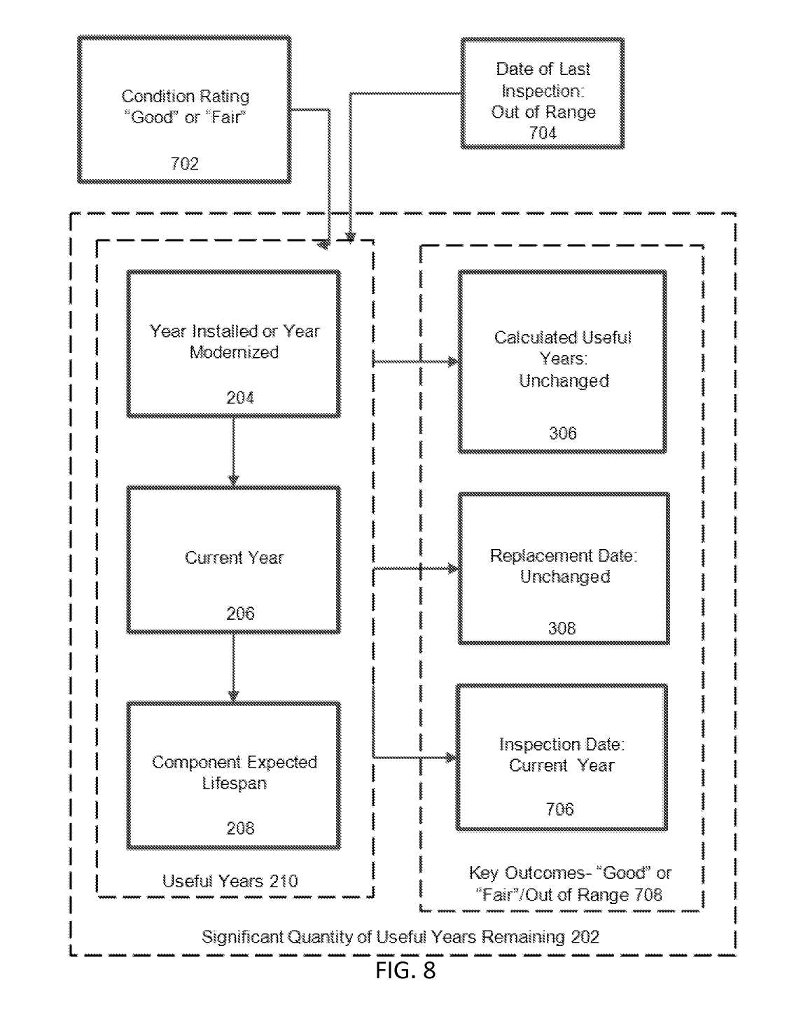

FIG. 8 illustrates a block diagram of how the Useful Years, the Replacement Date, and the Inspection Date are determined and conditioned by the component Condition Rating 702 and Date of the Last Inspection 704, in accordance with another embodiment disclosed herein. Many facility components may not need to be inspected until closer to the end of the Expected Lifespan. Good maintenance practices and the need for an accurate predictive maintenance system calls for inspections to occur within a reasonable time frame even if the condition of the component was good or fair when last inspected and the component is likely to have many years of service remaining. Here, the component was last evaluated as being in good or fair condition, as indicated by Condition Rating “Good” or “Fair” 702 and typically would have many years of service left, as indicated by Significant Quantity of Useful Years Remaining 202, but the time between inspections has been too long, as indicated by Last Inspection Date: Out of Range 704. Under these conditions, the Useful Years 306 and Replacement Date 308 may be unchanged, but the Inspection Date 706 indicates immediate inspection warranted. This is shown with the Key Outcome blocks Calculated Useful Years: Unchanged 306, Replacement Date: Unchanged 308, and Inspection Date: Current Year 706. This combination of Key Outcomes, grouped for these conditions is indicated by the dashed block Key Outcomes 708—“Good” or “Fair”/Out of Range.

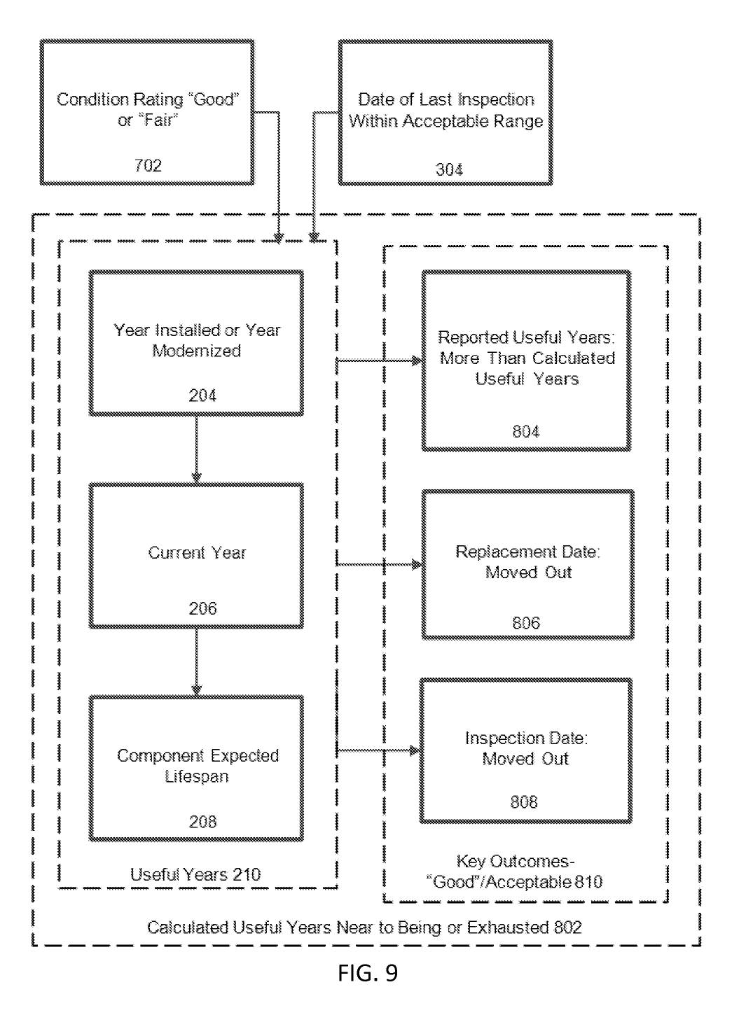

FIG. 9 illustrates a block diagram of how the Useful Years, the Replacement Date, and the Inspection Date are determined and conditioned by the component Condition Rating 302 and Date of the Last Inspection 304, and the timing within the lifespan of the component, in accordance with another embodiment disclosed herein. Here, the component Condition Rating is good or fair as indicated by Condition Rating “Good” or “Fair” 702, and the date of the last inspection is within an acceptable range as indicated by Last Inspection Date Within Acceptable Range 304. Until now, the various condition ratings and other conditioning variables have served to accelerate or move up the inspection and replacement schedules. Good routine maintenance practices and favorable environmental factors may enable components to remain serviceable beyond a typical Expected Lifespan. FIG. 9 reflects the situation where the component Expected Lifespan is nearing or has perhaps already gone beyond the Expected Lifespan of the component as indicated with Calculated Useful Years Near to Being or Exhausted 802. Nevertheless, the component has been evaluated as being in good or fair condition as indicated by Condition Rating “Good” or “Fair” 702, and it has not been excessively long since the last inspection, as indicated by Last Inspection Date 304. Under these favorable conditions, the inspection and replacement schedules may be adjusted to extend or “move out” the schedules, and the reported years for the Useful Life variable may be increased. This is indicated by Reported Useful Years: More Than Calculated Useful Years 804, Replacement Date: Moved Out 806, and Inspection Date: Moved Out 808. This combination of Key Outcomes, grouped for this condition is indicated by the dashed block Key Outcomes—“Good”/Acceptable 810.

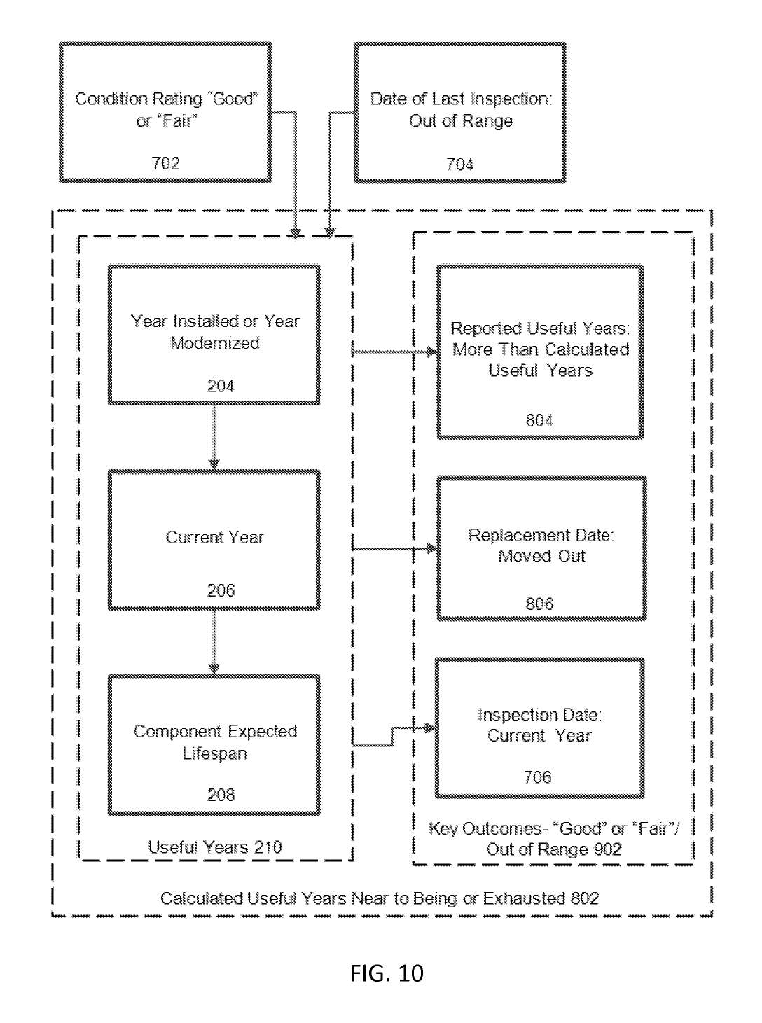

FIG. 10 illustrates a block diagram of how the Useful Years, the Replacement Date, and the Inspection Date are determined and conditioned by the component Condition Rating 702 and Date of the Last Inspection 704, in accordance with another embodiment disclosed herein. Here, the component Condition Rating is good or fair as indicated by Condition Rating “Good” or “Fair” 702. The date of the last inspection is beyond the acceptable range as indicated by Last Inspection Date Out of Range 704, and the component is near the end of its typical Expected Life or may have even exceeded the Expected Life as indicated by a Calculated Useful Years Near to Being or Exhausted 802. It has been too long since the last inspection to ensure that the last Condition Rating still describes the wear status of the component. This is indicated by Last Inspection Date: Out of Range 704. Since the last rating was still good or fair, as indicated by Condition Rating “Good” or “Fair” 702, time may be added to the Reported Useful Years 804 and the Replacement Date 806 may be extended as shown in Reported Useful Years: More Than Calculated Useful Years 804 and Replacement Date: Moved Out 806. The database 32 may call for an inspection as indicated by Inspection Date: Current Year 706, in accordance with the embodiments described herein. This combination of Key Outcomes, grouped for these conditions is indicated by the dashed block Key Outcomes—“Good” or “Fair”/Out of Range 902.

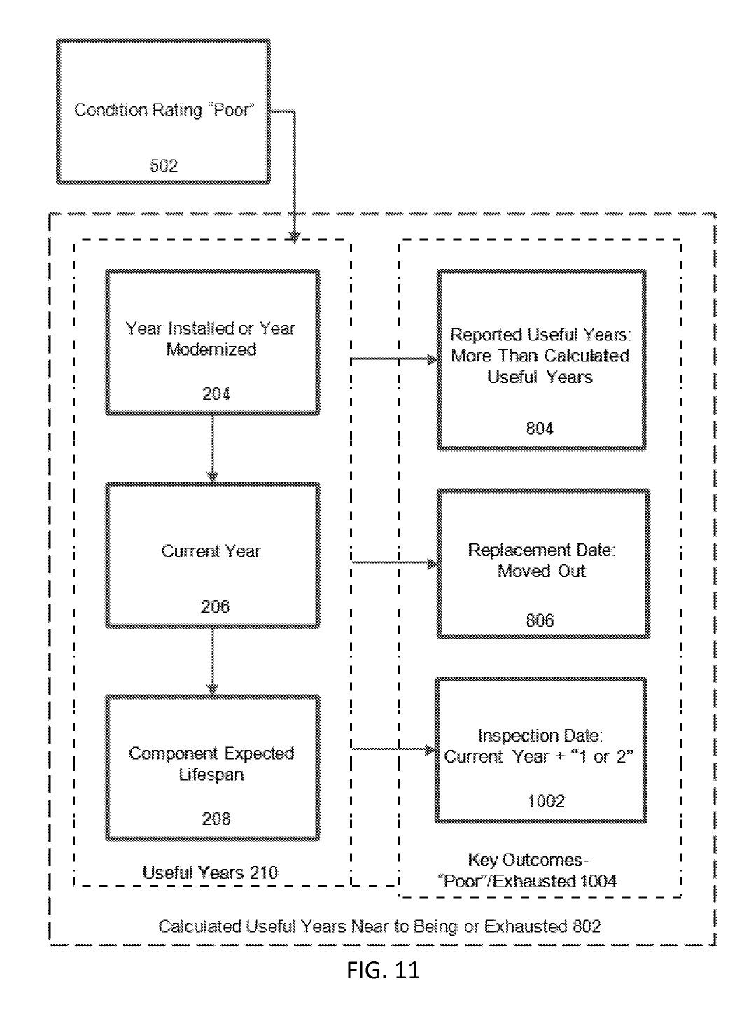

FIG. 11 illustrates a block diagram of how the Useful Years, the Replacement Date, and the Inspection Date are determined and conditioned by the component Condition Rating 502, in accordance with another embodiment disclosed herein. The re-inspection triggered by the Out of Range condition described in FIG. 10 may lead to the component being evaluated as now in poor condition, which will eventually occur no matter how excellent the quality of the routine maintenance or how favorable the environmental conditions (even if the component was managed to exceed its Expected Lifespan as indicated in Calculated Useful Years Near to Being or Exhausted 802). Here the component has been rated to be in poor condition as shown by Condition Rating “Poor” 502. As a result, while the poor rating will cause the database 42 to shave years off of the previously Reported Useful Years 804 and shorten the predicted Replacement Date 806, compared to the Calculated Useful Years 802, the Reported Useful Years 804 still exceeds the Calculated Useful Years as shown in Reported Useful Years: More Than Calculated Useful Years 804 and Replacement Date: Moved Out 806. One embodiment disclosed herein may cause the next Inspection Date 1002 to be eminent, with the exact amount depending on the settings and the component type. This is indicated by Inspection Date: Current Year+“1 or 2” 1002. This combination of Key Outcomes, grouped for these conditions is indicated by the dashed block Key Outcomes—“Poor”/Exhausted 1004.

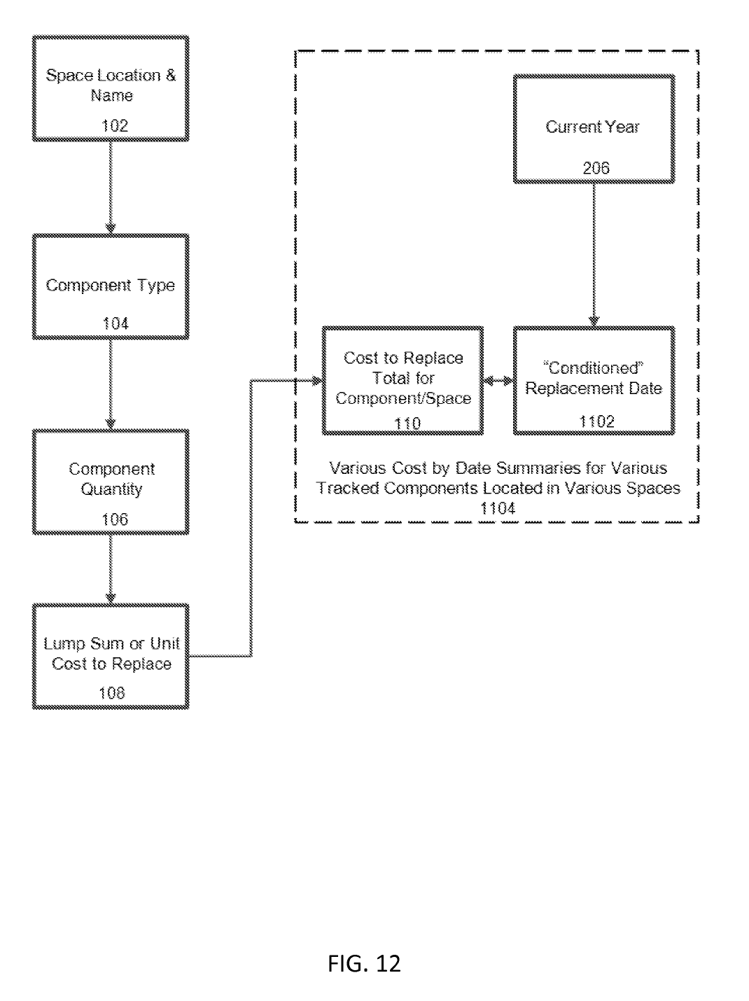

FIG. 12 illustrates a block diagram of how a “Conditioned” Replacement Date 1102 and a Various Cost by Date Summaries for Various Tracked Components Located in Various Spaces 1104 are determined, in accordance with another embodiment disclosed herein. Previously, FIG. 2 illustrated the derivation for the Cost to Replace Total for Component/Space 110. FIGS. 3-11 also illustrated variables that condition the Useful Years, the Replacement Date, and the Inspection Date values to take into account lifecycle timing, facility operator component wear evaluations, and the timing of inspections to ensure that the facilities predictive maintenance program is accurate. The Replacement Date for a component that has been conditioned in this way is represented by “Conditioned” Replacement Date 1102. The conditioned replacement date for a component is paired with the estimated cost to replace the component as shown in Cost to Replace Total for Component/Space 110 (derived from Space Location & Name 102, Component Type 104, Component Quality 106, and Lump Sum or Unit Cost to Replace 108). This provides an overview of the years specific costs are likely to be incurred for specific components in specific locations. One embodiment disclosed herein allows for various groupings of costs, locations, and components as indicated by the dashed block Various Cost by Date Summaries for Various Tracked Components Located in Various Spaces 1104. Thus, this information can be shown in fine detail or aggregated.

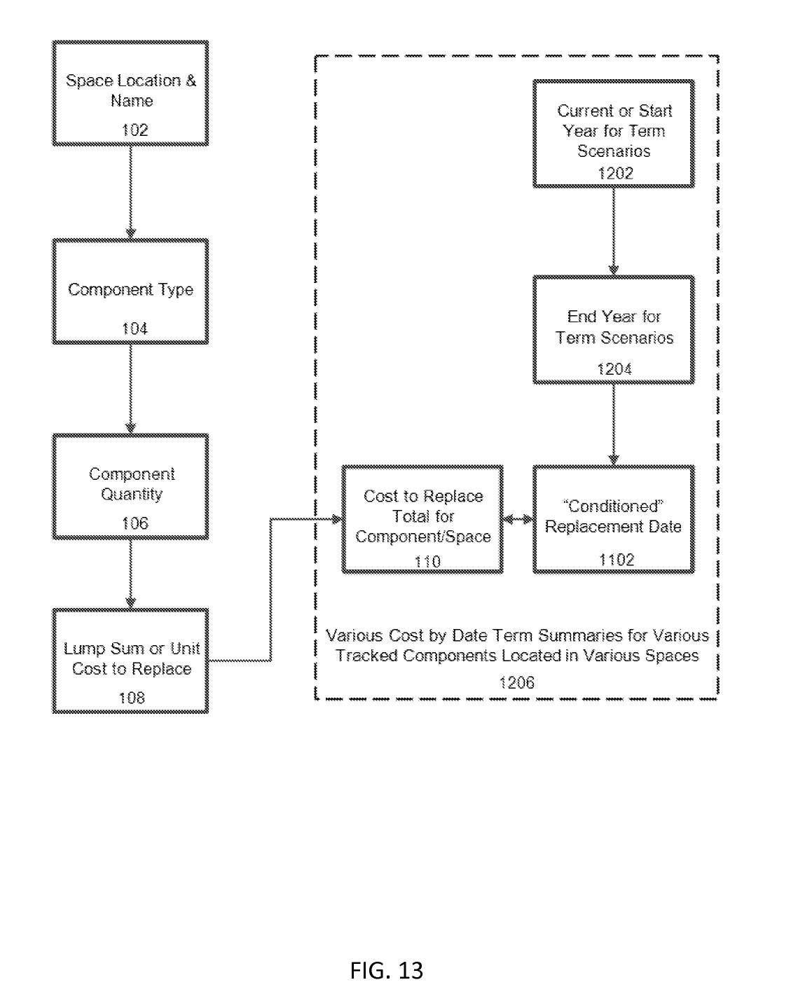

FIG. 13 illustrates a block diagram of how the “Conditioned” Replacement Date 1102 and Various Cost by Date Summaries for Various Tracked Components Located in Various Spaces 1206 are determined, in accordance with one embodiment disclosed herein. It is often helpful to consider various time periods or “terms” when forecasting a budget. For example, California school districts are required to provide the State with the projected costs for maintenance in a five year plan, while the school board may want to consider the maintenance liabilities over a twenty year period. One embodiment disclosed herein allows for this type of planning by providing the option to enter the start and end years for analyzing various terms as shown in Current or Start Year for Term Scenarios 1202 and End Year for Term Scenarios 1204. One embodiment disclosed herein provides summaries for various groupings of costs, locations, and components when considering various time periods as indicated by the dashed block Various Cost by Date Term Summaries for Various Tracked Components Located in Various Spaces 1206. A Cost to Replace Total for Component/Space 110 is derived from Space Location & Name 102, Component Type 104, Component Quality 106, and Lump Sum or Unit Cost to Replace 108. The Current or Start Year for Term Scenarios 1202 and End Year for Term Scenarios 1204 are used to determine the “Conditioned” Replacement Date 1102.

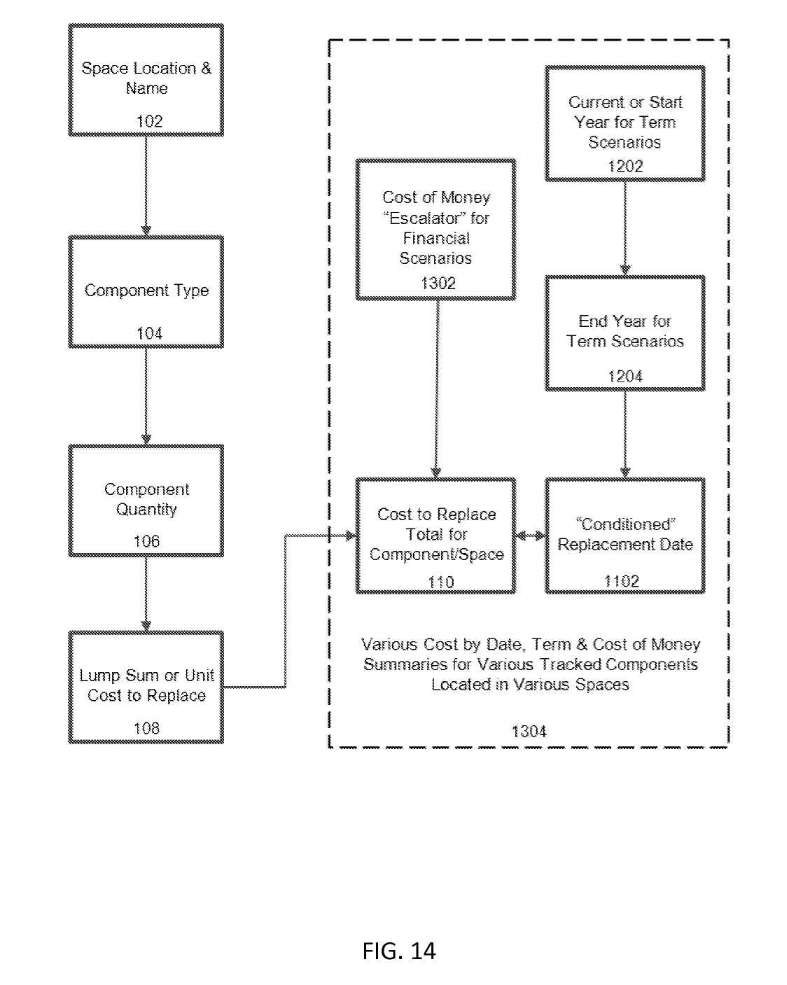

FIG. 14 illustrates a block diagram of how to determine Various Cost by Date, Term & Cost of Money Summaries for Various Tracked Components Located in Various Spaces 1304, in accordance with another embodiment disclosed herein. Here, planning may start by entering the start and end years for analyzing various terms as shown in Current or Start Year for Term Scenarios 1202 and End Year for Term Scenarios 1204. A Cost to Replace Total for Component/Space 110 is derived from Space Location & Name 102, Component Type 104, Component Quality 106, and Lump Sum or Unit Cost to Replace 108. The Current or Start Year for Term Scenarios 1202 and End Year for Term Scenarios 1204 are used to determine the “Conditioned” Replacement Date 1102. Accordingly, it is possible to consider how different interest rates will affect a maintenance budget over time by entering different interest rates, as shown in the Cost of Money “Escalator” for Financial Scenarios 1302. One embodiment disclosed herein automatically adjusts the different summaries as indicated by Various Cost by Date, Term & Cost of Money Summaries for Various Tracked Components Located in Various Spaces 1304.

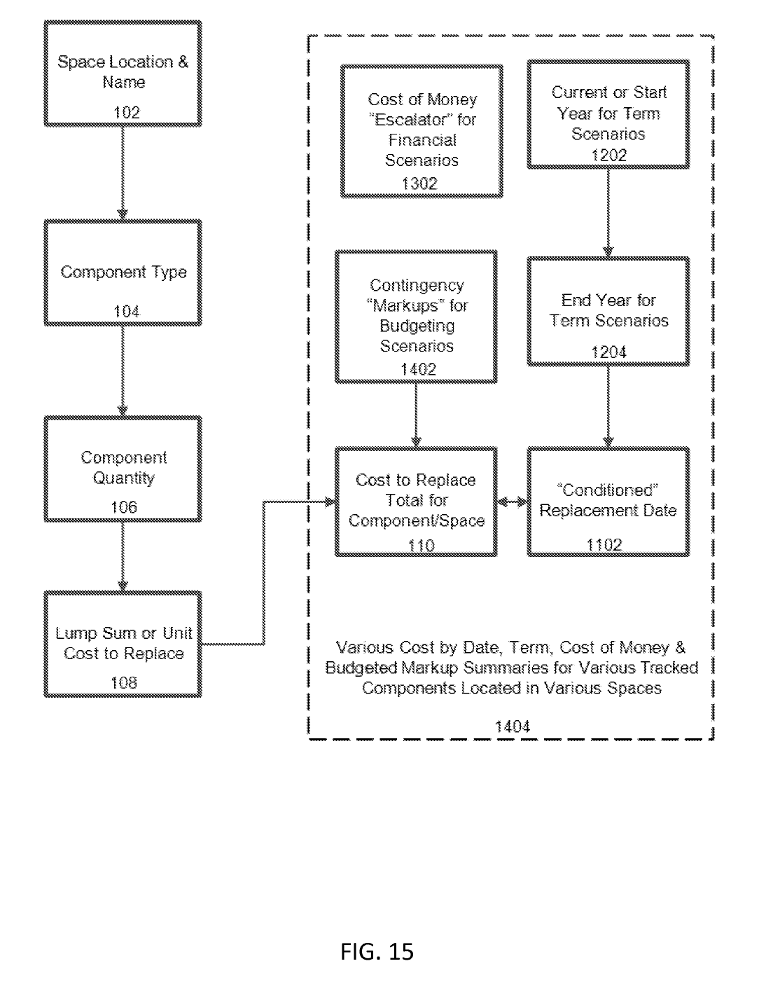

FIG. 15 illustrates a block diagram of how to determine Various Cost by Date, Term, Cost of Money, & Project Markup Summaries for Various Tracked Components Located in Various Spaces 1404, in accordance with another embodiment disclosed herein. Planning a capital improvement program requires taking into consideration all project costs such as design costs and construction management costs in addition to the direct cost of replacing a component. The former project costs are often referred to as “soft costs” and the latter “hard costs.” Sound planning also requires that contingency funds be budgeted to allow for unforeseen conditions and other difficult to predict program costs. FIG. 15 illustrates escalation of the predicted budgets beyond the hard cost values to allow for soft costs and contingency needs as shown in Contingency “Markups” for Budgeting Scenarios 1402. One embodiment disclosed herein automatically adjusts the different summaries as indicated by Various Cost by Date, Term & Cost of Money & Budgeted Markup Summaries for Various Tracked Components Located in Various Spaces 1404. This type of planning provides the option to enter the start and end years for analyzing various terms as shown in Current or Start Year for Term Scenarios 1202 and End Year for Term Scenarios 1204. Summaries for various groupings of costs, locations, and components may be generated when considering various time periods, as indicated by the dashed block Various Cost by Date Term Summaries for Various Tracked Components Located in Various Spaces 1404. A Cost to Replace Total for Component/Space 110 is derived from Space Location & Name 102, Component Type 104, Component Quality 106, and Lump Sum or Unit Cost to Replace 108. The Current or Start Year for Term Scenarios 1202 and End Year for Term Scenarios 1204 are used to determine the Conditioned Replacement Date 1102. Facility financial planners are able to consider how different interest rates overtime will affect the maintenance budget requirements by entering different interest rates, as shown in the Cost of Money “Escalator” for Financial Scenarios 1302. The database 42 may automatically adjust the different summaries as indicated by Various Cost by Date, Term & Cost of Money Summaries for Various Tracked Components Located in Various Spaces 1404.

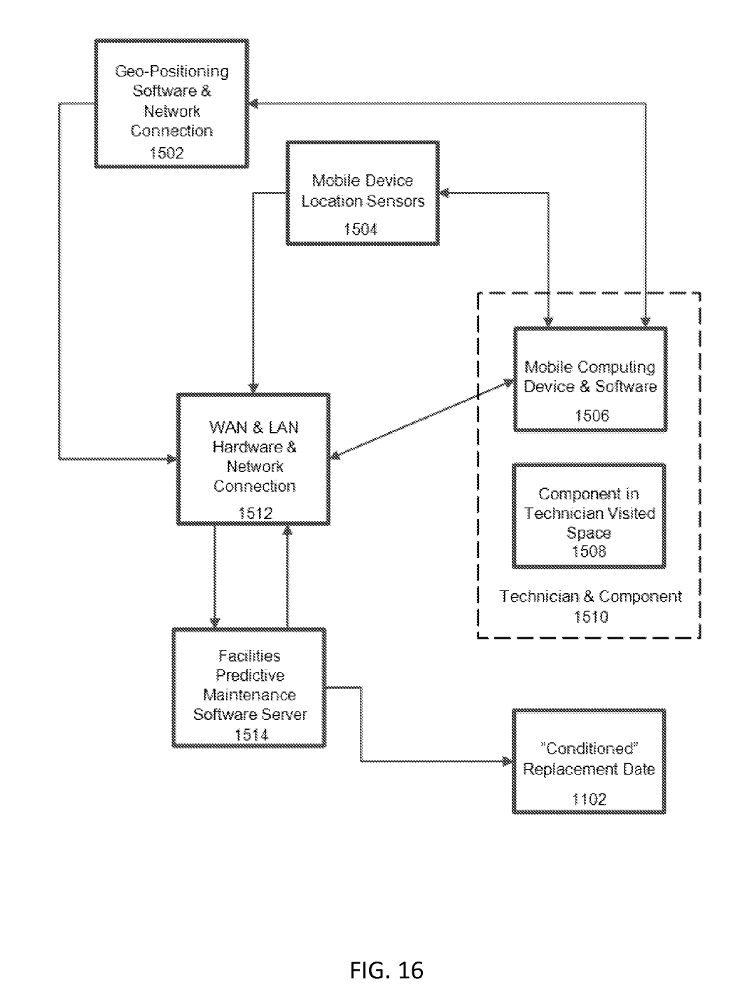

FIG. 16 illustrates a block diagram of how the updating of the condition ratings through inspections can be done rapidly by incorporating inspection alerts and inspection updates into the course of daily maintenance operations by using existing technologies, as described above. In one embodiment, geo-positioning devices, sensors located in facility spaces, or a combination thereof can be used to identify the location of the aforementioned portable electronic device 72 carried by the maintenance technician 70, as shown in Geo-Positioning Software & Network Connection 1502, Mobile Device Location Sensors 1504 and Mobile Computing Device & Software 1506. When combined with network hardware and software typically used to enable wireless communication within buildings as indicated by WAN & LAN Hardware & Network Connection 1512, the portable electronic device 72 can be connected with the database 42 running server software, and as generally indicated in FIG. 16 as the Facilities Predictive Maintenance Software Server 1514. In one embodiment, the Facilities Predictive Maintenance Software Server 1514 can search the inspection schedules and popup reminders when inspections are needed. The technician 70 can then be guided to the appropriate component, represented here by Component in Technician Visited Space 1508, in the area where the technician 70 is working and the technician 70 can enter the component condition updates into the portable electronic device 72 to be communicated over the communication network 38 to the database 42. This interplay is indicated by the dashed box Technician & Component 1510. The uploaded condition updates are then used by the database 42 to update the replacement date for the component as represented by “Conditioned” Replacement Date 1102. The Technician 70 can also proactively update the condition of a component without regard to the planned inspection schedule.

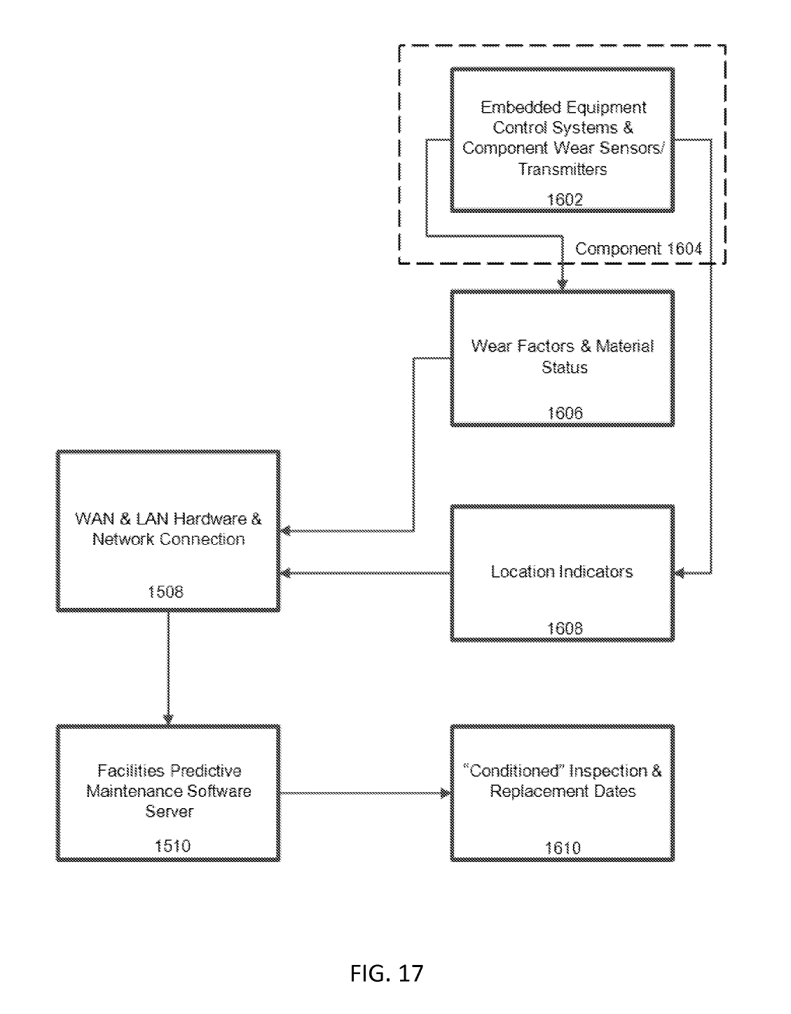

FIG. 17 illustrates a block diagram of how the automation of condition ratings can allow for existing technologies, in accordance with one embodiment disclosed herein. This embodiment takes the automation of condition ratings a step further by allowing for existing technologies like HVAC & Lighting control technology and Building Automation Systems to report equipment conditions that can be used to evaluate component status. Emerging technologies, such as nanotechnology, may be incorporated into various materials making it possible for certain materials to report wear status directly to the database 42 by way of wired or wireless communications, as mentioned above. For example, liquid applied roofing membranes may be able to indicate when key qualities needed for water resistance, such as elasticity, have been degraded by time and weather to the point where failure is eminent. A wand type reader might be needed in this case to pick up the membranes signaling parts. These existing and emerging technologies are indicated generally by Equipment Control Systems & Component Wear Sensors/Transmitters 1602, acting on or within Component 1604 represented by the dashed box. The component may be able to identify its location, as indicated by Location Indicators 1608, and transmit wear factor and status information, as indicated by Wear Factors & Material Status 1606. This information can then automatically upload via WAN & LAN Hardware & Network Connection 1508 to Facilities Predictive Maintenance Software Server 1510 where the database 42 may incorporate the information to automatically update the component condition rating and the related inspection and replacement schedules indicated by “Conditioned” Inspection & Replacement Dates 1610.

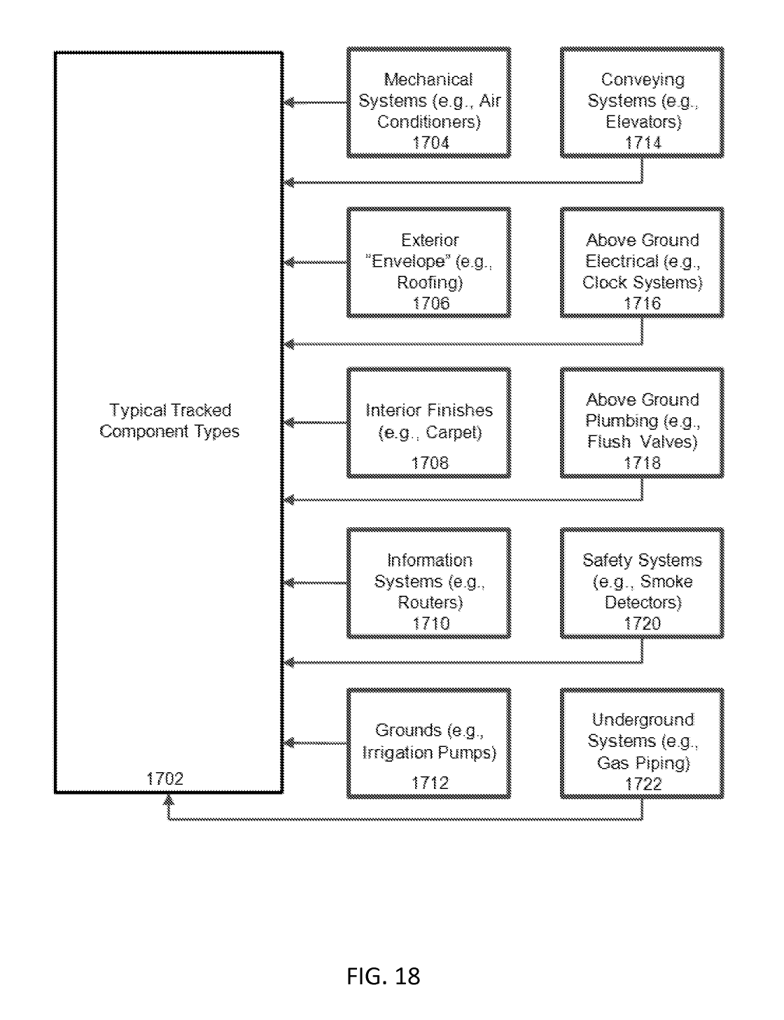

FIG. 18 illustrates a typical facility and the typical tracked components, in accordance with another aspect of the present disclosure. Although not exhaustive of major facility component categories, FIG. 18 lists Typical Tracked Component Types 1702 that may contain numerous components. Typical Tracked Components include Mechanical Systems (e.g., Air Conditioners) 1704, Exterior Envelopes (e.g., Roofing) 1706, Interior Finishes (e.g., Carpet) 1706, Information Systems (e.g., Routers) 1710, Grounds (e.g., Irrigation Pumps) 1712, Conveying Systems (e.g., Elevators) 1714, Above Ground Electrical (e.g., Clock Systems) 1716, Above Ground Plumbing (e.g., Flush Valves) 1718, Safety Systems (e.g., Smoke Detectors) 1720, and Underground Systems (e.g., Gas Piping) 1722. These component categories feed into Typical Tracked Component Types 1702.

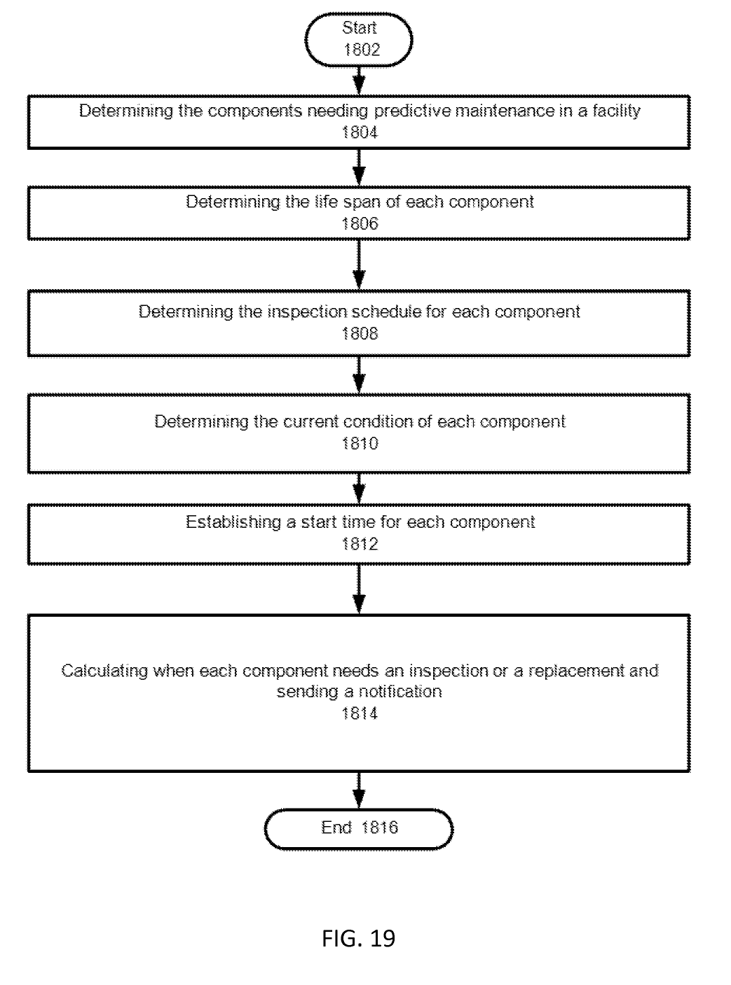

FIG. 19 illustrates a process for facilitating facilities maintenance scheduling. More specifically, the process begins in operation 1802. The next step is to determine the components needing predictive maintenance in a facility 1804. The next step includes determining the life span of each component 1806. The next step is to determine the inspection schedule of each component 1808 followed by determining the current condition of each component 1810. Thereafter, a start time for each component is established as part of step 1812. The next step is to calculate when each component needs an inspection or a replacement and sending a notification 1814. The process then ends as part of step 1816.

Although several embodiments have been described in detail for purposes of illustration, various modifications may be made without departing from the scope and spirit of the invention. Accordingly, the invention is not to be limited, except as by the appended claims.

What is claimed is:

1. A process for facilities maintenance scheduling, comprising the steps of:
storing at least one operational characteristic of at least one component requiring inspection over a service lifetime in a database;
monitoring the operational characteristic of the at least one component with a sensor;
communicating a status of the operational characteristic monitored by the sensor to the database over a communication network;
updating the operational characteristic in the database based on the status received from the sensor over the communication network; and
adjusting an inspection schedule of the at least one component based on the status of the operational characteristic received by the database from the sensor over the communication network.

2. The process of claim 1, including the step of sending an alert to a portable electronic device that the at least one component requires inspection.

3. The process of claim 2, including the step of identifying a location of the portable electronic device with a geo-locator.

4. The process of claim 3, wherein the at least one component comprises a plurality of components and wherein the alert at least includes the inspection schedule for the plurality of components within a predetermined range of the location of the portable electronic device.

5. The process of claim 2, including the step of receiving an inspection update in the database from the portable electronic device, the inspection update comprising a completed inspection or a deferred inspection.

6. The process of claim 1, wherein the monitoring step includes the step of the querying the operational characteristic at periodic intervals with the sensor.

7. The process of claim 6, wherein the sensor comprises an RFID reader, a portable electronic device, a gauge, or a nanotechnology sensor built into the at least one component.

8. The process of claim 1, wherein the status comprises a condition rating for the at least one component comprising a good rating, a fair rating, a poor rating, or a replace rating.

9. The process of claim 8, wherein the adjusting step includes the step of accelerating the inspection schedule for the at least one component when the condition rating comprises the poor rating or the replace rating.

10. The process of claim 8, wherein the adjusting step includes the step of extending the inspection schedule for the at least one component when the condition rating comprises the good rating or the fair rating.

11. The process of claim 1, wherein the inspection schedule for the at least one component is based at least in part on a quantity of useful years, a component condition, and a date the at least one component was last inspected.

12. The process of claim 1, wherein the at least one component comprises multiple components having multiple operational characteristics, including creating an inspection schedule, a replacement schedule, and a cost schedule based on the status of the multiple operational characteristics of the multiple components in the database.

13. The process of claim 1, including the step of tagging the at least one component as a critical component.

14. The process of claim 1, wherein the adjusting step includes the step of modifying the inspection schedule based at least in part on an environmental wear condition.

15. A process for facilities maintenance scheduling, comprising the steps of:
storing at least one operational characteristic of a plurality of components in a database;
monitoring the at least one operational characteristic for each of the plurality of components with one or more sensors;
communicating a status of each of the at least one operational characteristic of the plurality of components monitored by the one or more sensors to the database over a communication network, wherein the status comprises a condition rating comprising a good rating, a fair rating, a poor rating, or a replace rating;
updating the at least one operational characteristic for each of the plurality of components in the database based on the status received from the one or more sensors over the communication network;
adjusting an inspection schedule for the plurality of components based on the status of the respective operational characteristic received by the database from the one or more sensors over the communication network, including accelerating the inspection schedule when the condition rating comprises the poor rating or the replace rating or extending the inspection schedule when the condition rating comprises the good rating or the fair rating; and
sending an alert to a portable electronic device with the inspection schedule for at least a portion of the plurality of components within a predetermined range of the portable electronic device when at least one component requires inspection.

16. The process of claim 15, including the steps of identifying a location of the portable electronic device with a geo-locator and receiving an inspection update in the database from the portable electronic device, the inspection update comprising a completed inspection or a deferred inspection, wherein the monitoring step includes the step of the querying the operational characteristic at periodic intervals with the one or more sensors.

17. The process of claim 15, including the step of creating an inspection schedule, a replacement schedule, and a cost schedule based on the status of the plurality of components in the database, wherein the inspection schedule is based at least in part on a quantity of useful years, a component condition, and a date that each of the at least one operational characteristic was last inspected.

18. A facilities maintenance system, comprising:
a database storing at least one operational characteristic of a component requiring maintenance over a service lifetime;
at least one sensor deployed relative to the component and in a position to monitor the at least one operational characteristic of the component during the service lifetime;
a communication network coupled with the database and the sensor for exchanging information therebetween, including a status of the operational characteristic monitored by the sensor; and
at least one portable electronic device in communication with the database over the communication network, the at least one portable electronic device receiving an inspection schedule from the database over the communication network based at least in part on the status of the operational characteristic monitored by the sensor.

19. The system of claim 18, wherein the sensor comprises a moisture sensor, a fabric sensor, a nanotechnology sensor built into the at least one component, or a pressure sensor.

20. The system of claim 18, wherein the communication network comprises a wireless or a wired communication network and the portable electronic device comprises a smartphone or a tablet.
